(19) United States
(12) Patent Application Publication
(10) Pub. No.: US 2021/0230411 A1
(43) Pub. Date: Jul. 29, 2021

(54) Ethylene Acrylic Acid Copolymers

(71) Applicant: ExxonMobil Chemical Patents Inc., Baytown, TX (US)

(72) Inventor: Jacob H. Jordahl, Webster, TX (US)

(21) Appl. No.: 17/151,333

(22) Filed: Jan. 18, 2021

Related U.S. Application Data
(60) Provisional application No. 62/966,807, filed on Jan. 28, 2020.

(51) Int. Cl. C08L 23/08

(52) U.S. Cl. CPC C08L 23/0869

(57) ABSTRACT

The present disclosure relates to copolymers including ethylene and α,β unsaturated carboxylic acid units, such as acrylic acid. Copolymers may include from about 0.4 mol % to about 1.1 mol % of the α,β unsaturated carboxylic acid units, and have a melt index of from about 0.1 g/10 min to about 2 g/10 min. Alternatively, copolymers may include from about 0.4 mol % to about 2.4 mol % α,β unsaturated carboxylic acid units, and have a melt index of from about 0.1 g/10 min to about 1.4 g/10 min.

### CROSS-REFERENCE

This application claims the benefit of U.S. Provisional Application Number 62/966807, filed Jan. 28, 2020, entitled “Ethylene Acrylic Acid Copolymers”, the entirety of which is incorporated by reference herein.

### FIELD

The present disclosure relates to ethylene acrylic acid (EAA) copolymers, and particularly to EAA with low melt index and low acrylic acid content.

### BACKGROUND

Increased demand for local food, flower, and plant based products has caused an increase in the use of greenhouses used to provide climate control for vegetation growth. Greenhouses may include clear or translucent coverings that allow the sun's rays to provide light and warmth. Furthermore, climate control often includes sufficient water and humidity for plant growth. The warm humid environment often produces fog or water condensation on the greenhouse walls or coverings. Water condensation may decrease the passage of sunlight into the greenhouse and increase the frequency at which greenhouse coverings must be replaced. Ideally, a greenhouse covering would allow sufficient sunlight to pass through (has a low haze and/or high clarity), decrease condensation (have anti-fog or anti-drip capacity), be low cost, easily installed, and be durable (lasting more than a couple of years). Additionally, produce bags and food packaging may involve similar desired properties, for example, can allow sufficient view of the product (e.g., the bag or packing has a low haze and/or high clarity), decrease condensation (have anti-fog or anti-drip capacity), can be low cost, and can be easily formed into bags for produce and food products.

Polyolefin films are frequently used to produce greenhouses because of their low cost, processability, durability, ease of use, and low haze. Similar films may be used in the grocery industry for produce bags and food packaging. Such films often have a low melt index so that during the blown film process they can produce large bubbles (greater than 6 m) used in production of some films. Additionally, the longevity of a film used on a greenhouse structure is affected by the film's creep and stiffness, with a high creep resistance and high stiffness providing improved film life. Furthermore, the application of films across a greenhouse structure is much easier if the film is not sticky. Stickiness and clarity may be affected by the crystalline and amorphous phases of a polyolefin. The use of polymer blend may sacrifice clarity and/or increase stickiness and may not be desirable in final film formulations.

When used in greenhouse applications polyolefin films may include anti-fog and/or anti-drip additives to reduce or eliminate the formation of droplets on the surface of the films by altering the surface energy at the film surface. This enhances light penetration into the greenhouse, increasing the utility of the film for greenhouse use. The thin water layer on the surface of the greenhouse film may cause the anti-fog and anti-drip additives to leach out of the polyolefin films. The subsequent decrease in additives present in the film may decrease the lifetime and, therefore, value and utility of the film. Additionally, a decrease in additives reduces the anti-fog and anti-drip performance of a film.

There is a need for films and/or layers of films that retain anti-fog and anti-drip additives for greater periods of time improving the lifetime, value, and utility of the film. Additionally, there is a need for films that are not too sticky and are processable in large bubble structures including films with a low melt index, such as from 0.1 g/10 min to 2 g/10 min. Other properties, such as resistance to creep, can further extend the lifetime of these films, as they are suspended across support structures for extended periods of time, across wide ranges of temperatures.

Additional information may be found in any of the following: U.S. Pat. Nos. 3,215,657; 3,215,678; 3,239,370; 3,365,520; 3,373,223; 3,454,280; 3,464,949; 3,520,861; 3,658,741; 3,884,857; 3,988,509; 4,248,990; 4,252,924; 4,351,931; 4,417,035; 4,599,392; 4,678,836; 4,788,265; 4,988,781; 5,384,373; 6,562,906; 6,852,792; 7,279,513; 7,777,145 PCT Publication Nos. WO201745199; WO201745198; WO2014106625; WO201410626; WO201546443; WO201546131; WO201579953; WO2017114614; European Patent Nos. EP2038331; EP2129522; EP770658; EP1152027; EP3067386; EP1628826; Japanese Patent Nos. JP4966614; JP4563853; JP4503159; JP4563908; JP4741953; JP4010967; JP4902266; JP3707422; JP5080438; Japanese Patent Publication Nos. JP2014018997; JP2014018109; JP2016130274; JP20017052918; JP2018014980; French Patent No. FR2773100; Chinese Patent No. CN106633319; CN101746095B; and CN106633322.

### SUMMARY

The present disclosure relates to copolymers including ethylene and α,β unsaturated carboxylic acid units, such as acrylic acid. Copolymers may include from about 0.4 mol % to about 1.1 mol % of units derived from α,β unsaturated carboxylic acid, and have a melt index of from about 0.1 g/10 min to about 2 g/10 min. Alternatively, copolymers may include from about 0.4 mol % to about 2.4 mol % units derived from α,β unsaturated carboxylic acid, and have a melt index of from about 0.1 g/10 min to about 1.4 g/10 min.

### DETAILED DESCRIPTION

The use of an copolymer of ethylene and an α,β-unsaturated carboxylic acid (ECA) as a layer in a polyolefin film may reduce diffusion of anti-drip and anti-fog additives within the film. Reduced diffusion of the anti-drip and anti-fog additives may decrease extraction on the surface of the film (improve retention) and, therefore, improve film performance and lifetime.

The grade of ECA also affects its potential use as a greenhouse covering. For example, it has been discovered that an ECA with too high of an α,β-unsaturated carboxylic acid content would produce a film that is sticky and difficult to apply to the greenhouse structure. On the other hand, a film with too little α,β-unsaturated carboxylic acid content would not provide the desired retention of the anti-fog and anti-drip additives which improve film performance and lifetime. Similarly, films with a high melt index produce too small of a bubble in the blown film process for use as a greenhouse covering. Films with too low of a melt index may have increased gels and low processability.

Additionally, the use of a blend of ECA and other polyolefins typically implemented in greenhouse structures (such as low density polyethylene or ethylene vinyl acetate copolymers) might not provide the desired optical properties (high clarity and/or low haze) for use as a greenhouse covering.

It has been discovered that a film including a layer of about 100 wt % ECA (based on the total weight of the polymer in that layer) with an MI of about 0.1 g/10 min to about 2 g/10 min and an acrylic acid content of about 0.4 mol % to about 2.4 mol % may provide improved retention of the anti-fog and anti-drip additives, while retaining stiffness, high clarity, low haze, low creep, and low stickiness for use in greenhouse applications.

### Definitions

As used herein, a “polymer” may be used to refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other.

The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

Thus, as used herein, the terms “polyolefin,” “olefinic copolymer,” and “polyolefin component” mean a polymer or copolymer including olefin units of about 50 mol % or greater, about 70 mol % or greater, about 80 mol % or greater, about 90 mol % or greater, about 95 mol % or greater, or 100 mol % (in the case of a homopolymer). Polyolefins include homopolymers or copolymers of C2 to C20 olefins, e.g. a copolymer of an α-olefin and another olefin or α-olefin (ethylene is defined to be an α-olefin). Some examples of polyolefins include but are not limited to homopolyethylene, homopolypropylene, propylene copolymerized with ethylene and/or butene, ethylene copolymerized with one or more of propylene, butene or hexene, and optional dienes. Other examples include thermoplastic polymers such as ultra-low density polyethylene, very low density polyethylene, linear low density polyethylene, low density polyethylene, medium density polyethylene, high density polyethylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and compositions of thermoplastic polymers and elastomers, such as, for example, thermoplastic elastomers and rubber toughened plastics. The polyolefin may be produced in any suitable manner, including slurry, solution, gas phase, high pressure or other suitable processes, and by using catalyst systems appropriate for the polymerization of polyolefins, such as Ziegler-Natta-type catalysts, chromium catalysts, metallocene-type catalysts, other appropriate catalyst systems or combinations thereof, or by free-radical polymerization.

As used herein, the terms “polyethylene,” “ethylene polymer,” “ethylene copolymer,” “polyethylene component” and “ethylene based polymer” mean a polymer or copolymer including ethylene derived units of about 50 mol % or greater, about 70 mol % or greater, about 80 mol % or greater, about 90 mol % or greater, about 95 mol % or greater, or 100 mol % (in the case of a homopolymer). Furthermore, the term “polyethylene composition” means a composition containing one or more polyethylene components where the sum of ethylene derived units is greater than 50 wt %. The polyethylene compositions may be physical blends or in situ blends of more than one type of polyethylene or compositions of polyethylenes with polymers other than polyethylenes.

As used herein, when a polymer is referred to as including a monomer, the monomer is present in the polymer in the polymerized form of the monomer or in the derivative form of the monomer. Thus, a polymer may equivalently be referred to as including “units” of a monomer, and/or “units derived from” a monomer; both equivalently refer to the derivative or polymerized form of the monomer as found in a polymer after polymerization reaction of such monomer with other monomers and/or comonomers.

As used herein, when a polymer is said to include a certain weight percentage, e.g. wt %, of a monomer, that percentage of monomer is based on the total weight amount of monomer units in the polymer.

As used herein, when a polymer is said to include a certain molar percentage, e.g. mol %, of a monomer, that percentage of monomer is based on the total number of monomer units in the polymer.

Unless otherwise specified, the term “elastomer” as used herein, refers to a polymer or composition of polymers consistent with the ASTM D1566 definition.

For purposes of the present disclosure, an ethylene polymer having a density of 0.910 g/cm³ to 0.940 g/cm³ is referred to as a “low density polyethylene” (LDPE); an ethylene polymer having a density of 0.890 g/cm³ to 0.940 g/cm³, that is linear and does not contain a substantial amount of long-chain branching is referred to as “linear low density polyethylene” (LLDPE) and can be produced with suitable Ziegler-Natta catalysts, vanadium catalysts, or with metallocene catalysts in gas phase reactors, high pressure autoclave, and/or in slurry reactors and/or with the disclosed catalysts in solution reactors (“linear” means that the polyethylene has no or only a few long-chain branches, typically referred to as a g'vis of 0.97 or above, 0.98 or above); and an ethylene polymer having a density of more than 0.940 g/cm³ is referred to as a “high density polyethylene” (HDPE).

As used herein, “first” layer, “second” layer, and “third” layer (etc.) are merely identifiers used for convenience, and shall not be construed as limitation on individual layers, their relative positions, or the multi-layer structure, unless otherwise specified herein.

“Disposed on” may mean in contact with, coextruded with, disposed directly on or disposed indirectly on, unless otherwise specified.

### Ethylene α,β-Unsaturated Carboxylic Acid Copolymer

The ethylene α,β-unsaturated carboxylic acid (ECA) polymer is a random copolymer of ethylene and an α,β-unsaturated carboxylic acid, such as acrylic acid, methacrylic acid, ethylacrylic acid, propylacrylic acid, butylacrylic acid, cyanoacrylic acid, or combinations thereof In some embodiments, the ECA has from about 0.4 mol % to about 2.4 mol % of α,β-unsaturated carboxylic acid, based on the total number or monomer units within the ECA. In some embodiments, α,β-unsaturated carboxylic acid containing monomers, such as acrylic acid, methacrylic acid, or ethylacrylic acid can form about 0.4 mol % to about 2.4 mol % of the total polymer structure, based on the total number of monomer units within the ECA. In some embodiments, the ECA is an ethylene acrylic acid (EAA) copolymer, an ethylene methacrylic acid (EMAA) copolymer, an ethylene propylacrylic acid (EPAA) copolymer, an ethylene butylacrylic acid (EBAA) copolymer. Without being limited by theory, it is believed that the inclusion of an acid containing moiety in the ECA may provide hydrogen bonding to anti-drip and anti-fog additives and, thereby, decreases diffusion and subsequent extraction of such additive from the surface of greenhouse films. Additionally, the increased polarity of the ECA as compared to polyethylene homopolymers may provide additional reduction or elimination of diffusion and extraction of additives typically used in greenhouse films. Having higher bonding strength means that less comonomer is required to attain the same function as other ethylene copolymers, such as ethylene vinyl acetate, which allows for improved stiffness and reduced creep while maintaining or improving the retention of anti-drip or anti-fog additives. Without being limited by theory, the ECA polymer is generally a random copolymer of ethylene and an α,β-unsaturated carboxylic acid.

The ECA polymer may contain α,β-unsaturated carboxylic acid monomer incorporation from about 0.4 mol % to about 2.4 mol %, based on the total weight of the ECA. In some embodiments, the ECA polymer has from about 0.4 mol %, about 0.5 mol %, about 0.6 mol %, about 0.7 mol %, about 0.8 mol %, about 0.9 mol %, about 1 mol %, about 1.1 mol %, about 1.2 mol %, about 1.3 mol %, about 1.4 mol %, about 1.5 mol %, about 1.6 mol %, about 1.7 mol %, about 1.8 mol %, about 1.9 mol %, or about 2 mol % to about 1.1 mol %, about 1.2 mol %, about 1.3 mol %, about 1.4 mol %, about 1.5 mol %, about 1.6 mol %, about 1.7 mol %, about 1.8 mol %, about 1.9 mol %, about 2 mol %, about 2.1 mol %, about 2.2 mol %, about 2.3 mol %, or about 2.4 mol % of α,β-unsaturated carboxylic acid monomer incorporation based on the total number of monomer units within the ECA.

Correspondingly, the ethylene monomers and optional additional monomers may be present in an amount of about 94 wt %, about 94.1 wt %, about 94.2 wt %, about 94.3 wt %, about 94.4 wt %, about 94.5 wt %, about 94.6 wt %, about 94.7 wt %, about 94.8 wt %, about 94.9 wt %, about 95 wt %, about 95.1 wt %, about 95.2 wt %, about 95.3 wt %, about 95.4 wt %, about 95.5 wt %, about 95.6 wt %, about 95.7 wt %, about 95.8 wt %, about 95.9 wt %, about 96 wt %, about 96.1 wt %, about 96.2 wt %, about 96.3 wt %, about 96.4 wt %, about 96.5 wt %, about 96.6 wt %, about 96.7 wt %, about 96.8 wt %, about 96.9 wt %, about 97 wt %, about 97.1 wt %, about 97.2 wt %, about 97.3 wt %, about 97.4 wt %, about 97.5 wt %, about 97.6 wt %, about 97.7 wt %, about 97.8 wt %, or about 97.9 wt % to about 99 wt %, about 98.9 wt %, about 98.8 wt %, about 98.7 wt %, about 98.6 wt %, about 98.5 wt %, about 98.4 wt %, about 98.3 wt %, about 98.2 wt %, about 98.1 wt %, or about 98 wt % by weight of the ECA.

The α-olefin content (including ethylene and optional additional monomers) of the ECA polymer and/or the process parameters, such as temperature and pressure may be adjusted to vary the physical properties including: heat of fusion, melting point (Tm), crystallinity, melt index (MI_{2.16}), and melt index ratio (MI_{21.6}/MI_{2.16}).

The ECA polymer may include more than one comonomer (for example, to form a terpolymer, tetrapolymer, etc.). In some embodiments, comonomers include acrylic acid and one or more substituted acrylic acids, such as methacrylic acid, ethylacrylic acid, propylacrylic acid, butylacrylic acid, or cyanoacrylates. In at least one embodiment, a ECA polymer may have more than one comonomer including ethylene-vinyl acetate-acrylic acid, ethylene-methyl acrylic acid-acrylic acid, ethylene-ethyl acrylic acid-acrylic acid, ethylene-butyl acrylic acid-acrylic acid, ethylene-methyl acrylate-acrylic acid, ethylene-ethyl acrylate-acrylic acid, ethylene-butyl acrylate-acrylic acid or other terpolymers including ethylene and acrylic acid. In embodiments where one or more monomers derived from an acrylic acid are present, the amount of each monomer may be about 2.5 mol % or less of the ECA polymer. In some embodiments, the combined amount of α,β-unsaturated carboxylic acid monomers is about 0.5 mol % or greater, based on the total number of monomers within the ECA.

In some embodiments, the ECA polymer consists essentially of units derived from an α,β-unsaturated carboxylic acid and ethylene, meaning that the ECA polymer does not contain other comonomer in an amount greater than typically present as impurities in an ethylene and/or an α,β-unsaturated carboxylic acid feedstock, or random incorporation of process aids, chain transfer agents, molecular weight modifiers, or solvents used during the polymerization process or in an amount that would substantially affect the heat of fusion, melting point, crystallinity, melt index, or melt flow rate of the ECA polymer.

ECA polymers may be synthesized according to U.S. Pat. Nos. 4,351,931; 4,599,392; 4,988,781; 5,384,373.

### ECA Polymer Properties

In at least one embodiment, the ECA polymer has a heat of fusion (“Hf”), as determined by the Differential Scanning Calorimetry (“DSC”), of about 150 J/g or less, about 140 J/g or less, about 130 J/g or less, about 120 J/g or less, or about 110 J/g or less. In another embodiment, the ECA polymer may have an Hf of about 0.5 J/g or greater, about 10 J/g or greater, or about 20 J/g of greater. For example, the Hf value may be from about 1 J/g, about 10 J/g, about 30 J/g, about 40 J/g, about 50 J/g, or about 60 J/g, to about 70 J/g, about 80 J/g, about 90 J/g, about 100 J/g, about 110 J/g, about 120 J/g, or about 130 J/g.

The ECA polymer may have a percent crystallinity, as determined according to the DSC procedure described herein, of from about 10%, about 15%, about 20%, about 25% or about 30% to about 60%, about 55%, about 50%, or about 45%, of polyethylene.

The ECA polymer may have a single peak melting temperature as determined by DSC. In some embodiments, the copolymer has a primary peak temperature of 107° C. or less, with a broad end-of-melt transition of 110° C. or greater. The “peak melting point” (“Tm”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, and the principal peak (the highest of all peaks) being considered the Tm of the ECA polymer. The ECA polymer may have a Tm of about 80° C. or more, about 85° C. or more, about 90° C. or more, or about 95° C. or more. In some embodiments, the ECA polymer has a Tm of about 80° C. to about 130° C., about 85° C. to about 125° C., about 90° C. to about 120° C., or about 95° C. to about 115° C.

For the thermal properties of the ECA polymers, Differential Scanning Calorimetry (“DSC”) can be used. Such DSC data can be obtained using a Perkin-Elmer DSC, where 7.5 mg to 10 mg of a sheet of the polymer to be tested can be pressed at approximately 170° C. to 190° C., then removed with a punch die and annealed at room temperature for 48 hours. The samples can then be sealed in aluminum sample pans. The DSC data can be recorded by first cooling the sample to −20° C. and then gradually heating the sample to 200° C. at a rate of 10° C./minute. The sample can be kept at 200° C. for 5 minutes before a second cooling-heating cycle is applied. The sample is cooled at 10° C./minute until reaching −20° C. The sample is held here for 5 minutes before beginning the second heating cycle. The second heating ramp is also at 10° C./minute until reaching the ultimate temperature of 200° C. Both the first and second cycle thermal events are recorded. Areas under the melting curves are measured and used to determine the heat of fusion and the degree of crystallinity. The percent crystallinity (X%) is calculated using the formula, X%=[area under the curve (Joules/gram)/B(Joules/gram)]*100, where B is the heat of fusion for the homopolymer of the major monomer component. These values for B are found from the Polymer Handbook, Fourth Edition, published by John Wiley and Sons, New York 1999. A value of 293 J/g (B) is used as the heat of fusion for 100% crystalline polyethylene. The melting temperature is measured and reported during the second heating cycle (or second melt).

The ECA polymer may have a density of about 0.85 g/cm³ to about 0.95 g/cm³, about 0.9 g/cm³ to about 0.94 g/cm³, about 0.91 g/cm³ to about 0.93 g/cm³, at room temperature as measured per ASTM D-1505.

The ECA polymer may have a melt index (“MI_{2.16}”) of about 0.1 g/10 min or greater, such as about 0.2 g/10 min or greater, about 0.3 g/10 min or greater, about 0.4 g/10 min or greater, about 0.5 g/10 min or greater, about 0.6 g/10 min or greater, about 0.7 g/10 min or greater, about 0.8 g/10 min or greater, about 0.9 g/10 min or greater, or about 1 g/10 min or greater, and additionally a MI_{2.16} of about 2 g/10 min or less, about 1.9 g/10 min or less, about 1.8 g/10 min or less, about 1.7 g/10 min or less, about 1.6 g/10 min or less, about 1.5 g/10 min or less, about 1.4 g/10 min or less, or about 1.3 g/10 min or less. In some embodiments, an ECA polymer may have an MI_{2.16} of about 0.1 g/10 min to about 2 g/10 min, such as about 0.1 g/10 min to about 1.9 g/10 min, about 0.2 g/10 min to about 1.8 g/10 min, about 0.3 g/10 min to about 1.7 g/10 min, about 0.4 g/10 min to about 1.6 g/10 min, about 0.5 g/10 min to about 1.5 g/10 min, or about 0.5 g/10 min to about 1.4 g/10 min. The MI_{2.16} is determined according to ASTM D-1238, condition L (2.16 kg, 230° C.).

The ECA polymer may have a melt index ratio (MI_{21.6}/MI_{2.16}) of about 1 or greater, such as about 1.5 or greater, about 2 or greater, about 2.5 or greater, about 3 or greater, about 3.5 or greater, about 4 or greater, about 4.5 or greater, about 5 or greater, about 10 or greater, about 15 or greater, about 20 or greater, about 25 or greater, about 30 or greater, about 35 or greater, about 40 or greater, or about 45 or greater, and additionally a MI_{21.6}/MI_{2.16} of about 90 or less, about 80 or less, about 70 or less, about 65 or less, about 60 or less, about 55 or less, about 50 or less, about 45 or less, about 40 or less about 30 or less, about 28 or less, about 26 or less, about 24 or less, about 22 or less, about 20 or less, about 19 or less, about 18 or less, about 17 or less, about 16 or less, about 15 or less, about 14 or less, about 13 or less, about 12 or less, about 11 or less, about 10 or less, about 9 or less, or about 8 or less. In some embodiments, an EAA polymer may have an MI_{21.6}/MI_{2.16} of about 1 to about 90, such as about 2 to about 85, about 4 to about 80, about 10 to about 75, about 20 to about 70, about 25 to about 65, about 30 to about 55, about 35 to about 55, or about 40 to about 50. The MI_{21.6}/MI_{2.16} is determined according to ASTM D-1238.

The ECA polymer may have a Vicat softening temperature from about 40° C. to about 110° C., such as from about 45° C. to about 105° C., from about 50° C. to about 100° C., from about 60° C. to about 100° C., or from about 75° C. to about 90° C. In some embodiments, the ECA polymer consists essentially of units derived from unsubstituted acrylic acid and ethylene (EAA) and has a Vicat softening temperature from about 70° C. to about 110° C., such as from about 75° C. to about 105° C., from about 80° C. to about 100° C., or from about 85° C. to about 95° C.

The ECA polymer may have a weight average molecular weight (“Mw”) of about 5,000 g/mole to about 5,000,000 g/mole, about 10,000 g/mole to about 1,000,000 g/mole, or about 50,000 g/mole to about 400,000 g/mole; a number average molecular weight (“Mn”) of about 2,500 g/mole to about 1,000,000 g/mole, about 10,000 g/mole to about 250,000 g/mole, or about 20,000 g/mole to about 200,000 g/mole; and/or a z-average molecular weight (“Mz”) of about 50,000 g/mole to about 7,000,000 g/mole, about 100,000 g/mole to about 4,000,000 g/mole, or about 300,000 g/mole to about 2,000,000 g/mole. The ECA polymer may have a molecular weight distribution (Mw/Mn, or “MWD”) of about 1.5 to about 20, about 1.5 to about 15, about 1.5 to about 5, about 1.8 to about 5, or about 1.8 to about 4.

The ECA polymer may have an Elongation at Break of about 2000% or less, about 1000% or less, or about 800% or less, as measured per ASTM D412.

### ECA Polymer Production

ECA polymers may be produced by any suitable process, including free radical polymerization. In some embodiments, the ECA polymer is produced by heating ethylene, α,β-unsaturated carboxylic acid, and an initiator in an autoclave type reactor. Suitable initiators may include oxygen, peroxides, and azo bis compounds. In an embodiment, the ECA polymers are made as described in U.S. Pat. Nos. 4,351,931; 4,599,392; 4,988,781; 5,384,373.

### Polyethylenes

Polyethylene used for the multilayer film made according to a method of the present disclosure is selected from an ethylene derived homopolymer, an ethylene copolymer, or a composition thereof. Useful copolymers include one or more comonomers in addition to ethylene and can be a random copolymer, a statistical copolymer, a block copolymer, and/or compositions thereof.

Polyethylenes may be an HDPE, LLDPE, or LDPE, and may include those sold by ExxonMobil Chemical Company in Houston Tex. For example, a polyethylene can be one or more of those sold under the trade names ENABLE™, EXACT™, EXCEED™, ESCORENE™, EXXCO™, ESCOR™, PAXON™, and OPTEMA™ (ExxonMobil Chemical Company, Houston, Tex., USA); DOW™, DOWLEX™, ELITE™, AFFINITY™, ENGAGE™, and FLEXOMER™ (The Dow Chemical Company, Midland, Mich., USA); BORSTAR™ and QUEO™ (Borealis AG, Vienna, Austria); and TAFMER™ (Mitsui Chemicals Inc., Tokyo, Japan).

Example LLDPEs include linear low density polyethylenes having comonomer content from about 0.5 wt % to about 20 wt %, the comonomer derived from C₃ to C₂₀ α-olefins, e.g. 1-butene or 1-hexene. In various embodiments, the density of LLDPEs are from 0.890 g/cm³ to 0.940 g/cm³, from about 0.910 g/cm³ to about 0.930 g/cm³, or from about 0.912 g/cm³ to about 0.925 g/cm³. The MI of such LLDPEs can be about 0.1 g/10 min, about 0.2 g/10 min, or about 0.4 g/10 min to about 4 g/10 min, about 6 g/10 min, or about 10 g/10 min. LLDPEs are distinct from LDPEs which can be polymerized by free radical initiation and which contain a high amount of long chain branching resulting from intermolecular hydrogen transfer that does not occur in catalytic polymerization as used for LLDPE which favors chain end incorporation of monomers. In at least one embodiment, the LLDPEs are made using a single site (often metallocene) catalyst, in a gas phase or solution process. The use of a single site catalyst, even if supported on a catalyst support, such as silica, can lead to improved homogeneity of the polymer, such as an MWD from about 2 to about 4. In another embodiment, the LLDPEs are made using multi-site titanium based Ziegler Natta catalysts, in a gas phase or solution process. Generally LLDPE made from Zeigler Natta catalysts can be considered as having a broad compositional distribution with a CDBI of about 50% or less. LLDPEs may have an MWD determined according to the procedure disclosed herein of about 5 or less. In another embodiment, a layer may contain more than one type of LLDPE.

Example LDPEs include ethylene based polymers produced by free radical initiation at high pressure in a tubular or autoclave reactor. The LDPEs have a medium to broad MWD determined according to the procedure disclosed herein of about 4 or greater, or from about 5 to about 40, and a high level of long chain branching as well as some short chain branching. The density is generally about 0.910 g/cm³ or greater, such as from about 0.920 g/cm³ to about 0.940 g/cm³. The MI may be about 0.55 g/10 min or less or about 0.45 g/10 min or less. In the present disclosure, a layer may contain more than one type of LDPE.

Example HDPEs include high density polyethylenes having comonomer content from about 0.01 wt % to about 5 wt %, the comonomer derived from C₃ to C₂₀ α-olefins, e.g. 1-butene or 1-hexene, and in certain embodiments is a homopolymer of ethylene. In various embodiments, the density of HDPEs are from about 0.940 g/cm³ to about 0.970 g/cm³, from about 0.945 g/cm³ to about 0.965 g/cm³, or from about 0.950 g/cm³ to about 0.965 g/cm³. The MI of such HDPEs is from about 0.1 g/10 min, about 0.2 g/10 min, or about 0.4 g/10 min to about 4 g/10 min, about 6 g/10 min, or about 10 g/10 min. The HDPEs are typically prepared with either Ziegler-Natta or chromium-based catalysts in slurry reactors, gas phase reactors, or solution reactors. In the present disclosure, a layer may contain more than one type of HDPE.

Suitable commercial polymers for an HDPE may include those sold by ExxonMobil Chemical Company in Houston Tex., including HDPE HD and HDPE HTA and those sold under the trade names PAXON™ (ExxonMobil Chemical Company, Houston, Tex., USA); CONTINUUM™, DOW™, DOWLEX™, and UNIVAL™ (The Dow Chemical Company, Midland, Mich., USA). Commercial HDPE is available with a density of about 0.94 g/cm³ to about 0.963 g/cm³ and melt index (MI_{2.16}) of about 0.06 g/10 min. to about 33 g/10 min. Example HDPE polymers include:
ExxonMobil™ HDPE HTA 108 polyethylene has an MI of 0.70 g/10 min and density of 0.961 g/cm³, and is commercially available from ExxonMobil Chemical Company, Houston, Tex.
PAXON™ AA60-003 polyethylene has an MI of 0.25 g/10 min and density of 0.963 g/cm³, and is commercially available from ExxonMobil Chemical Company, Houston, Tex.
CONTINUUM™ DMDA-1260 polyethylene has an MI of 2.7 g/10 min and density of 0.963 g/cm³, and is commercially available from Dow Chemical Company, Midland, Mich.
UNIVAL™ DMDA-6147 polyethylene has an MI of 10 g/10 min and density of 0.948 g/cm³, and is commercially available from Dow Chemical Company, Midland, Mich.

In at least one embodiment, the polyethylene is an ethylene copolymer, either random or block, of ethylene and one or more comonomers selected from C₃ to C₂₀ linear, branched or cyclic monomers, often C₃ to C₂₀ α-olefins. Such polymers may have about 20 wt % or less, about 10 wt % or less, about 5 wt % or less, about 1 wt % or less, or from about 1 wt % to about 20 wt %, about 1 wt % to about 15 wt %, about 1 wt % to about 12.5 wt %, about 1 wt % to about 10 wt %, about 1 wt % to about 7.5 wt %, about 1 wt % to about 5 wt %, about 1 wt % to about 3 wt %, about 0.1 wt % to about 2 wt %, about 0.1 wt % to about 1 wt %, about 0.5 wt % to about 1 wt % of polymer units derived from one or more comonomers.

In at least one embodiment, the polyethylene includes propylene units of about 20 mol % or less, about 15 mol % or less, about 10 mol % or less, about 5 mol % or less, or about 0 mol % propylene units.

In some embodiments the comonomer is a C₄ to C₁₂ linear or branched alpha-olefin, e.g. 1-butene, 1-pentene, 1-hexene, 1-heptene, 1-octene, 1-nonene, 1-decene, 1-dodecene, 4-methyl-1-pentene, 3-methyl-1-pentene, 3,5,5-trimethyl-1-hexene, and 5-ethyl-1-nonene.

In certain embodiments, aromatic-group-containing monomers contain up to 30 carbon atoms. Suitable aromatic-group-containing monomers include at least one aromatic structure, from one to three aromatic structures, or a phenyl, indenyl, fluorenyl, or naphthyl moiety. The aromatic-group-containing monomer further includes at least one polymerizable double bond such that after polymerization, the aromatic structure will be pendant from the polymer backbone. The aromatic-group containing monomer may further be substituted with one or more hydrocarbyl groups including but not limited to C₁ to C₁₀ alkyl groups. Additionally, two adjacent substitutions may be joined to form a ring structure. In some embodiments, aromatic-group-containing monomers contain at least one aromatic structure appended to a polymerizable olefinic moiety. Examples of aromatic monomers include styrene, alpha-methylstyrene, para-alkylstyrenes, vinyltoluenes, vinylnaphthalene, allyl benzene, and indene; more specific examples include styrene, paramethyl styrene, 4-phenyl-1-butene and allyl benzene.

Diolefin monomers may include any suitable hydrocarbon structure, e.g. a C₄ to C₃₀, having at least two unsaturated bonds, where at least two of the unsaturated bonds are readily incorporated into a polymer by either a stereospecific or a non-stereospecific catalyst(s). The diolefin monomers may be selected from alpha, omega-diene monomers (e.g., di-vinyl monomers). The diolefin monomers may be linear di-vinyl monomers, containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, other example dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Example cyclic dienes include cyclopentadiene, vinylnorbornene, norbornadiene, ethylidene norbornene, divinylbenzene, dicyclopentadiene, or higher ring containing diolefins with or without substituents at various ring positions.

In some embodiments, one or more dienes are present in the polyethylene at about 10 wt % or less, such as about 0.00001 wt % to about 2 wt %, about 0.002 wt % to about 1 wt %, about 0.003 wt % to about 0.5 wt %, based upon the total weight of the polyethylene. In some embodiments, diene is added to the polymerization in an amount of from about 500 ppm, about 400 ppm, or about 300 ppm to about 50 ppm, about 100 ppm, or about 150 ppm.

Polyethylene copolymers can include about 50 wt % or more ethylene and have a C₃ to C₂₀ comonomer, C₄ to C₈ comonomer, 1-hexene or 1-octene comonomer wt % of about 50 wt % or less, such as about 10 wt % or less, about 1 wt % or less, from about 1 wt % to about 30 wt %, or about 1 wt % to about 5 wt %, based upon the weight of the copolymer.

The polyethylene may include from about 70 mol % to 100 mol % of units derived from ethylene. The lower value on the range of ethylene content may be from about 70 mol %, about 75 mol %, about 80 mol %, about 85 mol %, about 90 mol %, about 92 mol %, about 94 mol %, about 95 mol %, about 96 mol %, about 97 mol %, about 98 mol %, or about 99 mol % based on the mol % of polymer units derived from ethylene. The polyethylene may have an upper ethylene value of about 80 mol %, about 85 mol %, about 90 mol %, about 92 mol %, about 94 mol %, about 95 mol %, about 96 mol %, about 97 mol %, about 98 mol %, about 99 mol %, about 99.5 mol %, about 99.9 mol % or 100 mol %, based on polymer units derived from ethylene. For polyethylene copolymers, the polyethylene copolymer may have about 50 mol % or less of polymer units derived from a comonomer, e.g. C₃-C₂₀ olefins or alpha-olefins. The lower value on the range of comonomer content may be about 25 mol %, about 20 mol %, about 15 mol %, about 10 mol %, about 8 mol %, about 6 mol %, about 5 mol %, about 4 mol %, about 3 mol %, about 2 mol %, about 1 mol %, about 0.5 mol % or about 0.1 mol %, based on polymer units derived from the comonomer. The upper value on the range of comonomer content may be about 30 mol %, about 25 mol %, about 20 mol %, about 15 mol %, about 10 mol %, about 8 mol %, about 6 mol %, about 5 mol %, about 4 mol %, about 3 mol %, about 2 mol %, or about 1 mol %, based on polymer units derived from the comonomer olefin. Any of the lower values may be combined with any of the upper values to form a range. Comonomer content is based on the total content of all monomers in the polymer.

### Polyethylene Properties

Polyethylene homopolymers and copolymers can have one or more of the following properties:
(a) a weight average molecular weight (Mw) of about 15,000 g/mol or more, such as from about 15,000 to about 2,000,000 g/mol, from about 20,000 to about 1,000,000 g/mol, from about 25,000 to about 800,000 g/mol, from about 30,000 to about 750,000 g/mol, from about 150,000 to about 400,000 g/mol, or from about 200,000 to about 350,000 g/mol as measured by size exclusion chromatography;
(b) a z-average molecular weight (Mz) to weight average molecular weight (Mw) (Mz/Mw) ratio about 1.5 or greater, such as about 1.7 or greater, or about 2 or greater. In some embodiments, the Mz/Mw ratio is from about 1.7 to about 3.5, from about 2 to about 3, or from about 2.2 to about 3 where the Mz is measured by sedimentation in an analytical ultra-centrifuge;
(c) a Tₘ of about 30° C. to about 150° C., such as about 30° C. to about 140° C., about 50° C. to about 140° C., or about 60° C. to about 135° C., as determined based on ASTM D3418-03;
(d) a crystallinity of about 5% to about 80%, such as about 10% to about 70%, about 20% to about 60%, about 30% or greater, about 40% or greater, or about 50% or greater, as determined based on ASTM D3418-03;
(e) a percent amorphous content of from about 40%, about 50%, about 60%, or about 70% to about 95%, about 70%, about 60%, or about 50% as determined by subtracting the percent crystallinity from 100;
(f) a heat of fusion of about 293 J/g or less, such as about 1 to about 260 J/g, about 5 to about 240 J/g, or about 10 to about 200 J/g, as determined based on ASTM D3418-03;
(g) a crystallization temperature (T_{c}) of about 15° C. to about 130° C., such as about 20° C. to about 120° C., about 25° C. to about 110° C., or about 60° C. to about 125° C., as determined based on ASTM D3418-03;
(h) a heat deflection temperature of about 30° C. to about 120° C., such as about 40° C. to about 100° C., or about 50° C. to about 80° C. as measured based on ASTM D648 on injection molded flexure bars, at 66 psi load (455 kPa);
(i) a shore hardness (D scale) of about 10 or more, such as about 20 or more, about 30 or more, about 40 or more, about 10 or less, or from about 25 to about 75 as measured based on ASTM D 2240;
(j) a density from about 0.9 g/cm³, about 0.905 g/cm³, about 0.910 g/cm³, about 0.912 g/cm³, about 0.915 g/cm³, about 0.918 g/cm³, about 0.92 g/cm³, about 0.925 g/cm³ about 0.93 g/cm³, or about 0.94 g/cm³ to about 0.95 g/cm³, about 0.94 g/cm³, 0.935 g/cm³, about 0.93 g/cm³, about 0.925 g/cm³, about 0.923 g/cm³, about 0.921 g/cm³, about 0.92 g/cm³, or about 0.918 g/cm³; or a density of about 0.94 g/cm³ or greater as measured in accordance with ASTM D-4703 and ASTM D-1505/ISO 1183;
(k) a melt index (MI or I_{2.16}) from about 0.05 g/10 min, about 0.1 g/10 min, about 0.15 g/10 min, about 0.18 g/10 min, about 0.2 g/10 min, about 0.22 g/10 min, about 0.25 g/10 min, about 0.28 g/10 min, about 0.3 g/10 min, about 0.5 g/10 min, about 0.7 g/10 min, about 1 g/10 min, or about 2 gr/10 min, to about 800 g/10 min, about 100 g/10 min, about 50 g/10 min, about 30 g/10 min, about 15 g/10 min about 10 g/10 min, about 5 g/10 min, about 3 g/10 min, about 2 g/10 min, about 1.5 g/10 min, about 1.2 g/10 min, about 1.1 g/10 min, about 1 g/10 min, about 0.7 g/10 min, about 0.5 g/10 min, about 0.4 gr/10 min, about 0.3 g/10 min, or about 0.2 gr/10 min, or about 0.1 g/10 min, as measured by ASTM D-1238-E (190° C./2.16 kg);
(l) a melt index ratio (MIR) of from about 10 to about 100, from about 15 to about 80, from about 10 to about 50, from about 16 to about 50, from about 15 to about 45, from about 20 to about 40, from about 20 to about 35, from about 22 to about 38, from about 20 to about 32, from about 25 to about 31, or from about 28 to about 30 as measured by ASTM D-1238-E (190° C./2.16 kg) and (190° C., 21.6 kg) the ratio of MI_{21.6} (190° C., 21.6 kg)/MI_{2.16} (190° C., 2.16 kg);
(m) a composition distribution breadth index (“CDBI”) of about 100% or less, about 90% or less, about 85% or less, about 75% or less, about 5% to about 85%, or about 10% to 75%. The CDBI may be determined using techniques for isolating individual fractions of a sample of the polymer, such as Temperature Rising Elution Fraction (“TREF”), as described in Wild. et al., J. Poly. Sci., Poly. Phys. Ed., Vol. 20, p. 441 (1982);
(n) a molecular weight distribution (MWD) or (Mw/Mn) of about 40 or less, such as from about 1.5 to about 20, from about 1.8 to about 10, from about 1.9 to about 5, from about 1.5 to about 5.5, from about 1.5 to about 5, from about 2 to about 5, from about 2 to about 4, from about 3 to about 4.5, or from about 2.5 to about 4. MWD is measured using a gel permeation chromatograph (“GPC”) on a Waters 150 gel permeation chromatograph equipped with a differential refractive index (“DRI”) detector and a Chromatix KMX-6 on line light scattering photometer. The system is used at 135° C. with 1,2,4-trichlorobenzene as the mobile phase using Shodex (Showa Denko America, Inc.) polystyrene gel columns 802, 803, 804, and 805. The technique is discussed in “Liquid Chromatography of Polymers and Related Materials III,” J. Cazes editor, Marcel Dekker, 1981, p. 207. Polystyrene is used for calibration. No corrections for column spreading are employed; however, data on generally accepted standards, e.g., National Bureau of Standards Polyethylene 1484 and anionically produced hydrogenated polyisoprenes (alternating ethylene-propylene copolymers demonstrate that such corrections on MWD are less than 0.05 units). Mw/Mn is calculated from elution times. The numerical analyses are performed using the commercially available Beckman/CIS customized LALLS software in conjunction with the standard Gel Permeation package. Reference to Mw/Mn implies that the Mw is the value reported using the LALLS detector and Mn is the value reported using the DRI detector described above;
(o) a branching index of about 0.85 or greater, about 0.9 or greater, about 0.95 or greater, about 0.97 or greater, about 0.98 or greater, about 0.985 or greater, about 0.99 or greater, about 0.995 or greater, or about 1. Branching Index is an indication of the amount of branching of the polymer and is defined as

g′=[Rg]²_{br}[Rg]²ₗᵢₙ.

where “Rg” stands for Radius of Gyration and is measured using a Waters 150 gel permeation chromatograph equipped with a Multi-Angle Laser Light Scattering (“MALLS”) detector, a viscosity detector and a differential refractive index detector. “[Rg]_{br}” is the Radius of Gyration for the branched polymer sample and “[Rg]ₗᵢₙ” is the Radius of Gyration for a linear polymer sample; and/or
(p) an amount of long chain branching of about 2 long-chain branch/1000 carbon atoms or less, about 1 long-chain branch/1000 carbon atoms or less, about 0.5 long-chain branch/1000 carbon atoms or less, from about 0.05 to about 0.50 long-chain branch/1000 carbon atoms. Such values are characteristic of a linear structure that is consistent with a branching index (as defined above) of g′ᵥᵢₛ about 0.85 or greater, about 0.9 or greater, about 0.95 or greater, about 0.97 or greater, about 0.98 or greater, about 0.985 or greater, about 0.99 or greater, about 0.995 or greater, or about 1. Various methods are suitable for determining the presence of long-chain branches. For example, long-chain branching can be determined using ¹³C nuclear magnetic resonance (NMR) spectroscopy and to a limited extent; e.g., for ethylene homopolymers and for certain copolymers, and long-chain branching can be quantified using the method of Randall (Journal of Macromolecular Science, Rev. Macromol. Chem. Phys., C29 (2&3), p. 285-297). Although ¹³C NMR spectroscopy typically cannot determine the length of a long-chain branch in excess of about six carbon atoms, there are other suitable techniques useful for quantifying or determining the presence of long-chain branches in ethylene-based polymers, such as ethylene/1-octene interpolymers. For those ethylene-based polymers where the ¹³C resonances of the comonomer overlap completely with the ¹³C resonances of the long-chain branches, either the comonomer or the other monomers (such as ethylene) can be isotopically labelled so that the long-chain branches can be distinguished from the comonomer. For example, a copolymer of ethylene and 1-octene can be prepared using ¹³C-labeled ethylene. When labelled ethylene is used, the resonances associated with macromer incorporation will be significantly enhanced in intensity and will show coupling to neighboring ¹³C carbons, whereas the octene resonances will be unenhanced.

### Additional Polyethylene Embodiments

In at least one embodiment, the polyethylene is a first type of LLDPE (PE1-type) having about 99 wt % to about 80 wt %, about 99 wt % to about 85 wt %, about 99 wt % to about 87.5 wt %, about 99 wt % to about 90 wt %, about 99 wt % to about 92.5 wt %, about 99 wt % to about 95 wt %, or about 99 wt % to about 97 wt %, of polymer units derived from ethylene and about 1 wt % to about 20 wt %, about 1 wt % to about 15 wt %, about 1 wt % to about 12.5 wt %, about 1 wt % to about 10 wt %, about 1 wt % to about 7.5 wt %, about 1 wt % to about 5 wt %, or about 1 wt % to about 3 wt % of polymer units derived from one or more C₃ to C₂₀ α-olefin comonomers, such as C₃ to C₁₀ α-olefins, C₄ to C₈ α-olefins, or hexene and octene. The α-olefin comonomer may be linear or branched, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene.

The PE1-type polyethylene may have a composition distribution breadth index (CDBI) of about 70% or greater, such as about 75% or greater, about 80% or greater, about 82% or greater, about 85% or greater, about 87% or greater, about 90% or greater, about 95% or greater, or about 98% or greater. Additionally or alternatively, the CDBI may be about 100% or less, such as about 98% or less, about 95% or less, about 90% or less, about 87% or less, about 85% or less, about 82% or less, about 80% or less, or about 75% or less. Ranges expressly disclosed include, but are not limited to, ranges formed by combinations of any of the above-enumerated values, e.g., about 70% to about 98%, about 80 to about 95%, about 85 to about 90% etc.

A PE1-type polyethylene may have a density about 0.918 g/cm³ or greater, about 0.920 g/cm³ or greater, about 0.922 g/cm³ or greater, about 0.928 g/cm³ or greater, about 0.930 g/cm³ or greater, about 0.932 g/cm³ or greater. Additionally, a PE1-type polyethylene may have a density of about 0.945 g/cm³ or less, about 0.940 g/cm³ or less, about 0.937 g/cm³ or less, about 0.935 g/cm³ or less, about 0.933 g/cm³ or less, or about 0.930 g/cm³ or less. Ranges expressly disclosed include, but are not limited to, ranges formed by combinations of any of the above-enumerated values, e.g., about 0.920 g/cm³ to about 0.945 g/cm³, about 0.920 g/cm³ to about 0.930 g/cm³, about 0.925 g/cm³ to about 0.935 g/cm³, about 0.920 g/cm³ to about 0.940 g/cm³, etc.

A PE1-type polyethylene can be a metallocene polyethylene. The PE1-type polyethylene may have a g′ᵥᵢₛ of from about 0.85 to about 0.98, such as from about 0.87 to about 0.97, about 0.89 to about 0.97, about 0.91 to about 0.97, about 0.93 to about 0.95, about 0.97 to about 0.99, about 0.97 to about 0.98, or about 0.95 to about 0.98.

Suitable commercial polymers for the PE1-type polyethylene are available from ExxonMobil Chemical Company in Baytown, Tex. under the tradename Enable™. Polyethylene polymers known as Enable™ available from ExxonMobil Chemical Company, Houston, Tex., offer a combination of polymer film processing advantages and higher alpha olefin (HAO) performance. A balance of operational stability, extended output, versatility with HAO performance, and sourcing simplicity are among some of the advantageous properties of the Enable™ family of polyethylene polymers. Commercial Enable™ polyethylene is available with a density from about 0.92 g/cm³ to about 0.935 g/cm³ and melt index (MI_{2.16}) from about 0.3 g/10 min. to about 1 g/10 min. Other Enable™ polymers include:
Enable™ 2005 polyethylene has an MI of 0.5 g/10 min. and density of 0.920 g/cm³, and is commercially available from ExxonMobil Chemical Company, Houston, Tex.
Enable™ 2010 polyethylene has an MI of 1 g/10 min and density of 0.92 g/cm³, and is commercially available from ExxonMobil Chemical Company, Houston, Tex.
Enable™ 2703MC polyethylene has an MI of 0.3 g/10 min and density of 0.927 g/cm³, and is commercially available from ExxonMobil Chemical Company, Houston, Tex.
Enable™ 4002MC polyethylene has an MI of 0.25 g/10 min and a density of 0.94 g/cm³, and is commercially available from ExxonMobil Chemical Company, Houston, Tex.
Enable™ 4009MC polyethylene has an MI of 0.9 g/10min and a density of 0.94 g/cm³, and is commercially available from ExxonMobil Chemical Company, Houston, Tex.

In at least one embodiment, the polyethylene a second type of LLDPE (PE2-type) polyethylene including about 50 wt % or greater of polymer units derived from a C₃ to C₂₀ alpha-olefin comonomer (e.g. hexene or octene) of about 50 wt % or less, such as about 1 wt % to about 35 wt %, or about 1 wt % to about 6 wt %. PE2-type polyethylenes can have a CDBI of about 60% or greater, such as about 60% to about 80%, or about 65% to about 80%. The PE2-type polyethylene may have a density of about 0.910 g/cm³ to about 0.950 g/cm³, about 0.915 g.cm³ to about 0.940 g/cm³, or about 0.918 g/cm³ to about 0.925 g/cm³. PE2-type polyethylenes may have a melt index (MI_{2.16}) according to ASTM D1238 (190° C./2.16 kg) of about 0.5 g/10 min to about 5 g/10 min, or about 0.8 g/10 min to about 1.5 g/10 min. A PE2-type polyethylene can be a metallocene polyethylene. Such PE2-type polyethylenes can have a g′ᵥᵢₛ of about 0.97 or greater, about 0.98 or greater and can be a prepared by gas-phase polymerization supported catalyst with an bridged bis(alkyl-substituted dicyclopentadienyl) zirconium dichloride transition metal component and methyl alumoxane cocatalyst. PE2-type polyethylenes are available from ExxonMobil Chemical Company under the trade name Exceed™ and Exceed™ XP.

Polyethylene polymers known as Exceed™ and Exceed™ XP available from ExxonMobil Chemical Company, Houston, Tex., offer a combination of high toughness and outstanding tensile strength. A balance of impact strength, tear strength, flex-crack resistance, and melt-strength are among some of the advantageous properties of the Exceed™ family of polyethylene polymers. Commercial Exceed™ polyethylene is available with a density from about 0.91 g/cm³ to about 0.925 g/cm³ and melt index (MI_{2.16}) from about 0.2 g/10 min. to about 19 g/10 min. Other Exceed™ polymers include:
Exceed™ XP 6056ML polyethylene) has an MI of 0.5 g/10 min and a density of 0.916 g/cm³, and is commercially available from ExxonMobil Chemical Company, Houston, Tex.
Exceed™ 1018 polyethylene has an MI of 1 g/10 min and a density of 0.918 g/cm³, and is commercially available from ExxonMobil Chemical Company, Houston, Tex.
Exceed™ XP 8784 polyethylene has an MI of 0.8 g/10 min and a density of 0.914 g/cm³, and is commercially available from ExxonMobil Chemical Company, Houston, Tex.
Exceed™ 1012HA polyethylene has an MI of 1 g/10 min and a density of 0.912 g/cm³, and is commercially available from ExxonMobil Chemical Company, Houston, Tex.

### Polyethylene Production

The method of making the polyethylene can be performed or provided by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. Polyethylene homopolymers or copolymers that can be used may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. In an embodiment, the polyethylenes are made by the catalysts, activators and processes described in U.S. Pat. Nos. 5,466,649; 5,741,563; 6,255,426; 6,342,566; 6,384,142; 6,476,171; and 7,951,873; and WO Publication Nos. 2004/022646 and 2004/022634, 2003/040201 and 1997/19991. Such catalysts are described in, for example, ZIEGLER CATALYSTS (Gerhard Fink, Rolf Mülhaupt and Hans H. Brintzinger, eds., Springer-Verlag 1995 5); Resconi et al.; and I, II METALLOCENE-BASED POLYOLEFINS (Wiley & Sons 2000).

In at least one embodiment of the present disclosure, the polyethylene is produced by polymerization of ethylene and, optionally, an alpha-olefin with a catalyst having, as a transition metal component, a bis (n-C₃₋₄ alkyl cyclopentadienyl) hafnium compound, where the transition metal component includes from about 95 mol % to about 99 mol % of the hafnium compound as further described in U.S. Pat. No. 6,956,088.

In another embodiment, the polyethylene is produced by gas-phase polymerization of ethylene with a catalyst having as a transition metal component a bis(n-C₃₋₄ alkyl cyclopentadienyl) hafnium compound, where the transition metal component includes from about 95 mol % to about 99 mol % of the hafnium compound.

In a class of embodiments, the polyethylene may contain less than 5 ppm hafnium, less than 2 ppm hafnium, less than 1.5 ppm hafnium, or less than 1 ppm hafnium. In other embodiments, the polyethylene polymers may contain from about 0.01 ppm to about 2 ppm hafnium, from about 0.01 ppm to about 1.5 ppm hafnium, or from about 0.01 ppm to about 1 ppm hafnium.

Typically, the amount of hafnium is greater than the amount of zirconium in the polyethylene polymer. In a class of embodiments, the ratio of hafnium to zirconium (ppm/ppm) is about 2 or more, about 10 or more, about 15 or more, about 17 or more, about 20 or more, about 25 or more, about 50 or more, about 100 or more, about 200 or more, or about 500 or more. While zirconium generally is present as an impurity in hafnium, it will be realized in some embodiments where higher purity hafnium-containing catalysts are used, the amount of zirconium may be extremely low, resulting in a virtually undetectable or undetectable amount of zirconium in the polyethylene polymer. Thus, the upper value on the ratio of hafnium to zirconium in the polymer may be quite large.

### Ethylene Vinyl Acetate

In some embodiments multilayer films of the present disclosure may include a copolymer including monomers of ethylene and alkyl vinyl esters, such as ethylene vinyl acetate (EVA), as part of or the whole of one or more layers. The EVA may be a copolymer of ethylene and vinyl acetate, having a MI_{2.16}, of from about 0.2 to about 20 g/10 min, from about 0.2 to about 9 g/10 min, from about 0.2 to about 3 g/10 min, or from about 0.2 to about 1.5 g/10 min. The EVA may have a vinyl acetate content of from about 0.1 mol % to about 12 mol %, from about 0.5 mol % to about 9 mol %, or from about 1 mol % to about 7 mol %. EVA copolymers useful in the present invention may include those commercially available from ExxonMobil Chemical Company in Houston, Tex., such as Escorene™ Ultra FL series resins.

### Anti-Fog/Anti-Drip Additives

The polyethylene may be combined with various additives before being processed into a film or multilayer film. The additives may include anti-fog and/or anti-drip additives. The anti-fog and/or anti-drip additive typically provide for lowering the surface tension of water that may condense on the film, and may include surfactants. The lower surface tension allows for water to form a thin layer and stream down the sides of a green house without building up into droplets that may scatter light entering the greenhouse or may damage plants by dripping on them. Anti-fog and anti-drip additives may be present in the polyethylene in a combined wt % of from about 0.01 wt % to about 10 wt %, such as from about 0.02 wt % to about 9 wt %, from about 0.05 wt % to about 8 wt %, from about 0.1 wt % to about 7 wt %, from about 0.2 wt % to about 6 wt %, or from about 0.3 wt % to about 5 wt %.

The anti-drip and/or anti-fog additives may be any suitable surfactant, such as fluorine based surfactants, ethoxylated amines or amides, glycerol esters, nonionic surface active agent, an anionic surfactant, a cationic surfactant or the like, polyhydric alcohol esters composed of an polyhydric alcohol and a higher fatty acid, silicone-based surfactants, or combination(s) thereof.

Examples of anti-drip and/or anti-fog additives may include nonionic surfactants, such as sorbitan, glycerol, or pentaerythritol based surfactants. Sorbitan-based surfactants may include various sorbitan esters, such as sorbitan fatty acid esters, sorbitan stearic acid esters, sorbitan palmitic acid esters, other sorbitan esters, including monoesters, diesters, triesters, or mixture(s) thereof. Glycerol-based surfactants may include various glycerol esters, such as glycerol fatty acid esters, glycerol monopalmitate, glycerol monostearate, glycerol monolaurate, diglycerin monopalmitate, glycerol distearate, diglycerin monostearate, triglycerol monostearate, triglycerol distearate or mixture(s) thereof. Pentaerythritol-based surfactants may include various pentaerythritol esters, such as pentaerythritol fatty acid esters, pentaerythritol monopalmitate, pentaerythritol monostearate.

Examples of anti-drip and/or anti-fog additives may include ionic surfactants, such as sodium lauryl sulfate, sodium dodecyl benzene sulfonate, cetyl trimethyl ammonium chloride, dodecylamine hydrochloride, lauramide ethyl laurate phosphate, triethyl cetyl ammonium iodide, oleyl amino diethylamine hydrochloride, dodecyl pyridinium salts, isomer(s) thereof, or mixture(s) thereof.

Examples of anti-drip and/or anti-fog additives may include fluorine-based surfactants, such as previously listed example where instead of H bonded to C of the hydrophobic group, the hydrogen atom is substituted with fluorine, including surfactants having perfluoroalkyl group or perfluoroalkenyl group(s).

The film anti-dripping performance may be tested according to Chinese National Standard GB 4455-2006, where the film is clamped on a cage of a water bath to form an enclosed space and there is a 15 degree slope angle of the film generated by a pressing cone. The water in the water bath is heated to 60° C. to condense water vapor on the film. Condensed water flows back to the water bath and the anti-dripping agent may be gradually washed away. Non-transparent water droplets and/or transparent water flakes/streams may form onto the inner surface of the film, resulting in the loss of anti-dripping performance. The test continues until film failure. A film fails when either one of the following occurs (i) a non-transparent water droplet area larger than 30% of the total film area; or (ii) an area with water flakes/streams larger than 50% of the total film area. The failure may be recorded in a number of days the film lasted before failure.

### Other Additives

The polyethylene may be combined with additional additives and each layer may individually include various additives in varying quantities. Additional additives may include antioxidants, UV stabilizers, UV absorbers, IR reflectors used in greenhouse films, acid scavengers, nucleating agents, anti-blocking agents, slip agents, polymer processing agents, or combination(s) thereof. The amount of additional additives is typically less than 5 wt %, e.g. from about 0.0001 wt % to about 3 wt % calculated from the sum (wt %) of additives and polymer components present in a layer.

### Multilayer Films

The multilayer film includes a first layer, a second layer disposed on the first layer, and a third layer disposed on the second layer; each of the first layer, the second layer, and the third layer including a polyolefin polymer, optionally mixed with a polyethylene polymer or other polymers or additives. In some embodiments, at least one of the first layer, the second layer, or the third layer includes an ECA polymer in 100 wt % based on the weight of the polymer in that layer (not including the weight of additives, such as anti-drip, anti-fog, plasticizers, etc.) In some embodiments, the ECA polymer is an ethylene acrylic acid (EAA) copolymer. In some embodiments, the multilayer film includes in one or more layers a polyethylene composition including ethylene vinyl acetate (EVA).

The multilayer film may have a 1/2/3 structure where 1 is a first layer and 3 is a third layer and 2 is a second layer that is disposed between the first layer and the third layer. In some embodiments, one or both of the first layer and the third layer are an outermost layer forming one or both film surfaces. Either of the polyolefin of the first layer and the polyolefin of the third layer may have a higher or lower polarity than the polyolefin of the second layer. In some embodiments, at least one of the polyolefins of the first layer and the polyolefin of the third layer has a polarity lower than the polyolefin of the second layer. In at least one embodiment, the second layer includes 100 wt % ECA based on the weight of the polymer in that layer and has a higher polarity than the polyolefin of one or more of the other layers.

The multilayer film may have a 1/4/2/5/3 structure where 1 and 3 are outer layers and 2 represents a central or core layer and 4 and 5 are inner layers disposed between the central layer and an outer layer. The composition of the fourth layer and the fifth layer may be the same or different. The first layer may have the same composition or a different composition from the fourth layer and the fifth layer. In at least one embodiment, at least one of the fourth layer and fifth layer has a different composition than that of the first layer. In another embodiment, the fourth layer and the fifth layer have substantially the same chemical composition and are different from the first layer. In another embodiment, the first layer, the fourth layer and the fifth layer have substantially the same chemical composition.

In at least one embodiment, the LLDPE, LDPE, and HDPE present in a given layer may be optionally in a blend with one or more other polymers, such as polyethylenes defined herein, which blend is referred to as polyethylene composition as defined above. In some embodiments, the polyethylene composition is a blend of two polyethylenes with different densities, long chain branching content, or melt indexes.

In at least one embodiment, the polyethylene composition is an ethylene hexene (EH) copolymer blended with a second polyethylene. The second polyethylene may be the same as or different from the EH copolymer. In an embodiment where the polyethylene is different from the EH copolymer in a polyethylene composition, the polyethylene homopolymer in the homopolymer: copolymer blend may be present in an amount of about 50 wt % or less, about 45 wt % or less, about 40 wt % or less, about 35 wt % or less, about 30 wt % or less, about 25 wt % or less, about 20 wt % or less, about 15 wt % or less, about 10 wt % or less, or about 5 wt % or less, based on the total weight of polymer in the polyethylene composition.

In at least one embodiment, the first layer of the multilayer film includes about 100 wt % of an ethylene alpha-olefin (EAO) copolymer, based on the total weight of polymers in the first layer. In at least one embodiment, the polyolefin of the second layer of a multilayer film includes 100 wt % of an ECA copolymer, based on the total weight of polymer in the second layer. In some embodiments, each of the first layer and the third layer of a multilayer film includes about 100 wt % of an EAO copolymer, based on the total weight of polymer in each of the second layer and the third layer. In at least one embodiment, the polyolefin of the second layer of a multilayer film includes a polyethylene composition including an ECA. In another embodiment, the second layer of a multilayer film includes a polyethylene, having a density of about 0.910 g/cm³ to about 0.945 g/cm³, an MI_{2.16}, of about 0.1 g/10 min to about 15 g/10 min, an MWD of about 1.5 to about 5.5, and an MIR, MI_{21.6}/MI_{2.16}, of about 10 to about 100.

In at least one embodiment, the third layer of the multilayer film includes a polyethylene composition including one or more of (i) a polyethylene, (ii) a polyethylene copolymer, and (iii) an EAO copolymer. In another embodiment, the third layer of the multilayer film includes about 40% or greater, such as about 40 wt % to about 90 wt %, about 45 wt % to about 85 wt %, about 50 wt % to about 80 wt %, about 60 wt % to about 80 wt %, or about 65 wt % to about 75 wt % of a polyethylene copolymer and about 60 wt % or less, such as about 10 wt % to about 60 wt %, about 15 wt % to about 50 wt %, about 20 wt % to about 45 wt %, or about 25 wt % to about 40 wt %, or about 25 wt % to about 35 wt % of a polyethylene homopolymer, based on total weight of polymer in the third layer. In an embodiment, the polyethylene copolymer is an EAO copolymer. In some embodiments, the third layer includes about 100 wt % of an EAO copolymer, based on the total weight of polymer in the third layer. In some embodiments, the third layer includes a EH copolymer, having a density of about 0.910 g/cm³ to about 0.925 g/cm³, an MI_{2.16}, of about 0.1 g/10 min to about 2 g/10 min, an MWD of about 1.5 to about 5.5, and an MIR, MI_{21.6}/MI_{2.16}, of about 10 to about 100.

In at least one embodiment, each of the first layer, the second layer, and the third layer of a multilayer film include a polyethylene or polyethylene composition. In at least one embodiment, an EAO copolymer is present in the first layer and an EAO copolymer is present in the third layer. In some embodiments, the second layer includes about 100 wt % or a ECA based on the total weight of polymer in the second layer. In some embodiments, the first layer and the third layer includes about 100 wt % or a PE2-type EH copolymer based on the total weight of polymer in the third layer. In at least one embodiment, the second layer includes about 100 wt % of ECA based on the total weight of polymer in the second layer and the third layer includes about 100 wt % or a PE2-type EH copolymer based on the total weight of polymer in the third layer.

In at least one embodiment, a multilayer film has a three-layer 1/2/3 structure, including: (a) a first layer including about 100% of an EAO copolymer, based on total weight of polymer in the first layer; (b) a second layer disposed between the first layer and the third layer, including about 100 wt % of an ECA copolymer, based on total weight of polymer in the second layer, and (c) a third layer disposed on the second layer including about 100 wt % of an EAO copolymer, based on total weight of polymer in the third layer. In at least one embodiment, the EAO copolymers in the first layer and the third layer are EH copolymers, such as PE1-type or PE2-type polyethylenes.

In at least one embodiment, a multilayer film has a three-layer 1/2/3 structure, including: (a) a first layer including about 100% of an ECA copolymer, based on total weight of polymer in the first layer; (b) a second layer disposed between the first layer and the third layer, including about 100 wt % of an ECA copolymer, based on total weight of polymer in the second layer, where the ECA of the second layer has a higher α,β-unsaturated carboxylic acid content than the ECA of the first layer, and (c) a third layer disposed on the second layer including about 100 wt % of an EAO copolymer, based on total weight of polymer in the third layer. In at least one embodiment, the EAO copolymer in the third layer are EH copolymers, such as PE1-type or PE2-type polyethylenes.

In at least one embodiment, a multilayer film has a three-layer 1/2/3 structure, including: (a) a first layer including about 100% of an EVA copolymer, based on total weight of polymer in the first layer; (b) a second layer disposed between the first layer and the third layer, including about 100 wt % of an ECA copolymer, based on total weight of polymer in the second layer, and (c) a third layer disposed on the second layer including about 100 wt % of an EAO copolymer, based on total weight of polymer in the third layer. In at least one embodiment, the EAO copolymers in the first layer and the third layer are EH copolymers, such as PE1-type or PE2-type polyethylenes.

In at least one embodiment, a multilayer film has a three-layer 1/2/3 structure, including: (a) a first layer including about 100% of an ECA copolymer, based on total weight of polymer in the first layer; (b) a second layer disposed between the first layer and the third layer, including about 100 wt % of an EVA copolymer, based on total weight of polymer in the second layer, and (c) a third layer disposed on the second layer including about 100 wt % of an EAO copolymer, such as an EH copolymer or PE1-type polyethylene, based on total weight of polymer in the third layer.

In at least one embodiment, a multilayer film has a three-layer 1/2/3 structure, including: (a) a first layer including about 100% of an EAO copolymer, based on the total weight of polymer in the first layer, where the EAO copolymer has a density of about 0.92 g,/cm³ to about 0.94 g/cm³, an MI_{2.16}, of about 0.1 to about 1.5 g/10 min; (b) a second layer disposed between the first layer and the third layer, including about 100 wt % of an ECA copolymer, based on total weight of polymer in the second layer, where the ECA copolymer has a density of about 0.91 g/cm³ to about 0.93 g/cm³, an MI_{2.16}, of about 0.1 to about 2 g/10 min, and an acrylic acid content of about 1 wt % to about 6 wt %; and (c) a third layer disposed on the second layer including about 100 wt % of an EAO copolymer, based on total weight of polymer in the third layer, where the EAO copolymer has a density of about 0.91 g/cm³ to about 0.92 g/cm³, an MI_{2.16}, of about 0.1 to about 2 g/10 min.

In at least one embodiment, the multilayer film has a five layer 1/4/2/5/3 structure, including: (a) a first layer including about 100% of an EAO copolymer, based on total weight of polymer in the first layer; (b) a second layer disposed between the first layer and the third layer, including about 100 wt % of an ECA copolymer, based on total weight of polymer in the second layer; (c) a third layer disposed on the second layer including about 100 wt % of an EAO copolymer, based on total weight of polymer in the third layer; (d) a fourth layer, disposed between the first layer and the second layer, including a polyethylene or a polyethylene composition; and (e) a fifth layer, disposed between the second layer and the third layer, including a polyethylene or a polyethylene composition.

In another embodiment, the multilayer film includes in the fourth layer and/or the fifth layer independently at least one of LLDPE, LDPE and HDPE. The LLDPE, LDPE, HDPE or combination(s) thereof included independently in the fourth layer and/or the fifth layer may be present in an amount of about 30 wt % or greater, for example, from about 30 wt %, about 35 wt %, about 40 wt %, about 45 wt %, about 50 wt %, about 55 wt %, or about 60 wt %, to about 70 wt %, about 75 wt %, about 80 wt %, about 85 wt %, about 90 wt %, about 95 wt %, or about 100 wt %, based on the total weight of polymer in the layer. Each of the polymers of the second layer, the fourth layer, or the fifth layer may have a higher or lower density than the polyolefin of the first layer. In at least one embodiment, at least one of the polymers of the second layer, the fourth layer or the fifth layer has a density higher than the polyolefin of the first layer.

In some embodiments, the multilayer film includes in the fourth layer and/or the fifth layer independently ECA alone or as part of a polyethylene composition. The ECA in the fourth layer and/or the fifth layer may be present in an amount of about 30 wt % or greater, for example, from about 30 wt %, about 35 wt %, about 40 wt %, about 45 wt %, about 50 wt %, about 55 wt %, or about 60 wt %, to about 70 wt %, about 75 wt %, about 80 wt %, about 85 wt %, about 90 wt %, about 95 wt %, or about 100 wt %, based on the total weight of polymer in the layer. In some embodiments, the polyethylene of the second layer has a higher α,β-unsaturated carboxylic acid content (mol %) than the polyethylene of the fourth layer and/or the polyethylene of the fifth layer. In some embodiments, the polyethylene of the fourth layer and/or the fifth layer has a higher α,β-unsaturated carboxylic acid content than the polyethylene of the first layer and the polyethylene of the third layer. In some embodiments, the polyethylene of the second layer has a higher α,β-unsaturated carboxylic acid content than the polyethylene of the fourth layer and/or the polyethylene of the fifth layer and the polyethylene of the fourth layer and/or the fifth layer has a higher α,β-unsaturated carboxylic acid content than the polyethylene of the first layer and/or the third layer. In some embodiments, the fourth layer and the fifth layer are identical and include 100 wt % ECA based on the total weight of polymer within that layer (not including additives). In some embodiments, the first layer and the third layer are identical and include 100 wt % of an EAO copolymer. In some embodiments, the multilayer film has a 1/4/2/5/3 structure , including: (a) a first layer including about 100% of an EAO copolymer, based on total weight of polymer in the first layer; (b) a second layer disposed between the first layer and the third layer, including about 100 wt % of an EAO copolymer, based on total weight of polymer in the second layer; (c) a third layer disposed on the second layer including about 100 wt % of an EAO copolymer, based on total weight of polymer in the third layer; (d) a fourth layer, disposed between the first layer and the second layer, including about 100% of an ECA copolymer, based on total weight of polymer in the fourth layer; and (e) a fifth layer, disposed between the second layer and the third layer, including a about 100% of an EAO copolymer, based on total weight of polymer in the fifth layer. In some embodiments, the EAO copolymers in the first layer, the second layer, and the third layer are EH copolymers, such as PE1-type or PE2-type polyethylenes.

In some embodiments, the multilayer film has a 1/4/2/5/3 structure , including: (a) a first layer including about 100% of an EAO copolymer, based on total weight of polymer in the first layer; (b) a second layer disposed between the first layer and the third layer, including about 100 wt % of an EAO copolymer, based on total weight of polymer in the second layer; (c) a third layer disposed on the second layer including about 100 wt % of an ECA copolymer, based on total weight of polymer in the third layer; (d) a fourth layer, disposed between the first layer and the second layer, including about 100% of an EAO copolymer, based on total weight of polymer in the fourth layer; and (e) a fifth layer, disposed between the second layer and the third layer, including a about 100% of an ECA copolymer, based on total weight of polymer in the fifth layer. In some embodiments, the EAO copolymers in the first layer, the second layer, and the fourth layer are EH copolymers, such as PE1-type or PE2-type polyethylenes. In some embodiments, the ECA of the fifth layer has a greater than or equal to α,β-unsaturated carboxylic acid content than the ECA of the third layer.

In some embodiments, the multilayer film has a 1/4/2/5/3 structure , including: (a) a first layer including about 100% of an EAO copolymer, based on total weight of polymer in the first layer; (b) a second layer disposed between the first layer and the third layer, including about 100 wt % of an ECA copolymer, based on total weight of polymer in the second layer; (c) a third layer disposed on the second layer including about 100 wt % of an ECA copolymer, based on total weight of polymer in the third layer; (d) a fourth layer, disposed between the first layer and the second layer, including about 100% of an EAO copolymer, based on total weight of polymer in the fourth layer; and (e) a fifth layer, disposed between the second layer and the third layer, including a about 100% of an ECA copolymer, based on total weight of polymer in the fifth layer. In some embodiments, the EAO copolymers in the first layer and the fourth layer are EH copolymers, such as PE1-type or PE2-type polyethylenes. In some embodiments, the ECA of the fifth layer has an α,β-unsaturated carboxylic acid content greater than or equal than the ECA of the third layer and the ECA of the second layer has an α,β-unsaturated carboxylic acid content greater than or equal to the ECA of the fifth layer.

In some embodiments, the multilayer film has a 1/4/2/5/3 structure , including: (a) a first layer including about 100% of an PE2-type polyethylene, based on total weight of polymer in the first layer; (b) a second layer disposed between the first layer and the third layer, including about 100 wt % of an PE1-type copolymer, based on total weight of polymer in the second layer; (c) a third layer disposed on the second layer including about 100 wt % of an PE2-type polyethylene, based on total weight of polymer in the third layer; (d) a fourth layer, disposed between the first layer and the second layer, including about 100% of an ECA copolymer, based on total weight of polymer in the fourth layer, where the ECA copolymer has either i) a α,β-unsaturated carboxylic acid content of about 0.4 mol % to about 1.1 mol % and a MI2.16 of about 0.1 g/10 min to about 2 g/10 min or ii) a α,β-unsaturated carboxylic acid content of about 0.4 mol % to about 2.4 mol % and a MI2.16 of about 0.1 g/10 min to about 1.4 g/10 min; and (e) a fifth layer, disposed between the second layer and the third layer, where the polymer of the fifth layer is identical in chemical composition to the polymer of the fourth layer.

In some embodiments, the multilayer film has a 1/4/2/5/3 structure , including: (a) a first layer including about 100% of an EAO copolymer, based on total weight of polymer in the first layer; (b) a second layer disposed between the first layer and the third layer, including about 100 wt % of an EAO copolymer, based on total weight of polymer in the second layer; (c) a third layer disposed on the second layer including about 100 wt % of an EAO copolymer, based on total weight of polymer in the third layer; (d) a fourth layer, disposed between the first layer and the second layer, including about 100% of an EVA copolymer, based on total weight of polymer in the fourth layer; and (e) a fifth layer, disposed between the second layer and the third layer, including a about 100% of an EVA copolymer, based on total weight of polymer in the fifth layer. In some embodiments, the EAO copolymers in the first layer, the second layer, and the third layer are EH copolymers, such as PE1-type or PE2-type polyethylenes.

In some embodiments, the multilayer film has a 1/4/2/5/3 structure , including: (a) a first layer including about 100% of an PE2-type polyethylene, based on total weight of polymer in the first layer; (b) a second layer disposed between the first layer and the third layer, including about 100 wt % of an PE1-type copolymer, based on total weight of polymer in the second layer; (c) a third layer disposed on the second layer including about 100 wt % of an PE2-type polyethylene, based on total weight of polymer in the third layer; (d) a fourth layer, disposed between the first layer and the second layer, including about 100% of an EVA copolymer, based on total weight of polymer in the fourth layer; and (e) a fifth layer, disposed between the second layer and the third layer, where the polymer of the fifth layer is identical in chemical composition to the polymer of the fourth layer.

The multilayer films can have a thickness of about 0.1 mil to about 12 mil, such as about 0.5 mil to about 10 mil, about 1 mil to about 7 mil, or about 3 mil to about 5 mil. For a three-layer structure the first layer, the second layer and the third layer may be of equal thickness or alternatively the second layer may be thicker than each of the first layer and the third layer. In at least one embodiment, a multilayer film includes a first layer and a third layer which each independently forms about 10% to about 35%, or about 15% to about 30% of the total final thickness of the 3-layered film, the second layer forming the remaining thickness, e.g. about 30% to about 80%, or about 40% to about 70% of the total final thickness of the 3-layered film. The total thickness of the film is 100%, thus the sum of the individual layers has to be 100%.

For the multilayer film of 1/4/2/5/3 structure the individual layers can contribute to the total film thickness of the multilayer film in a variety of ways, for example: about 10% to about 30%, or about 15% to about 25% independently for each of the first layer and the third layer, about 5% to about 30%, or about 8% to about 20% independently for each of the fourth layer and the fifth layer, and/or about 10% to about 40%, or about 15% to about 35% for the second layer.

In some embodiments, the first layer, the third layer, the fourth layer, and the fifth layer are of equal thickness. In some embodiments, the first layer, the second layer and the third layer are of equal thickness. In at least one embodiment, the second layer, the fourth layer, and the fifth layer are of equal thickness. In another embodiment, the second layer has a thickness greater than the other layers. In some embodiments, all layers have the same thickness.

The multilayer film may further include additional layer(s), which may be a layer typically included in multilayer films. One or more layers that provide barrier enhancement are of interest in greenhouse applications. Additional layers may be added through any suitable method including, co-extrusion, extrusion coating, solid sublimation, or solvent or water based coatings. For example, the additional layer(s) may be made from:
1. Polyolefins. As described above.
2. Polar polymers. Polar polymers include homopolymers and copolymers of esters, amides, acetates, anhydrides, copolymers of a C₂ to C₂₀ olefin, such as ethylene and/or propylene and/or butene with one or more polar monomers, such as acetates, anhydrides, esters, alcohol, and/or acrylics. Examples include polyesters, polyamides, ethylene vinyl acetate copolymers, and polyvinyl chloride.
3. Cationic polymers. Cationic polymers include polymers or copolymers of geminally disubstituted olefins, α-heteroatom olefins and/or styrenic monomers. Geminally disubstituted olefins include isobutylene, isopentene, isoheptene, isohexane, isooctene, isodecene, and isododecene. α-Heteroatom olefins include vinyl ether and vinyl carbazole. Styrenic monomers include styrene, alkyl styrene, para-alkyl styrene, α-methyl styrene, chloro-styrene, and bromo-para-methyl styrene. Examples of cationic polymers include butyl rubber, isobutylene copolymerized with para methyl styrene, polystyrene, and poly-α-methyl styrene.
4. Miscellaneous. Other layers can be paper, wood, cardboard, metal, metal foils (such as aluminum foil and tin foil), metallized surfaces, glass (including silicon oxide (SiOx) or aluminum oxide (AlOx) coatings applied by evaporating SiOx or AlOx onto a film surface), fabric, spunbond fibers, and non-wovens (including polypropylene spunbond fibers or non-wovens), and substrates coated with inks, dyes, pigments, and the like.

As an example, a multilayer film can also include layers including materials such as ethylene vinyl alcohol (EVOH), polyamide (PA), polyvinylidene chloride (PVDC), or aluminum, so as to alter barrier performance for the film where appropriate.

It has been discovered that the use of ECA polymers in a layer of a polyethylene multilayer film has little or no negative effect on optical and mechanical properties of the multilayer film. Additionally, the use of ECA polymers in multilayer films may improve certain properties, such as creep resistance and stiffness. Also, addition of ECA polymers may improve retention of anti-drip and anti-fog additives increasing the lifetime and utility of a greenhouse film. As a result, the multilayer film can provide a convenient and cost-effective alternative to current options for greenhouse films where a balance of optical properties and overall film performance is expected.

### Multilayer Film Properties

For multilayer films, the properties and descriptions below are intended to encompass measurements in both the machine direction (MD) and the direction perpendicular to the MD (the transverse direction (TD)). Such measurements are reported separately, with the designation “MD” indicating a measurement in the machine direction, and “TD” indicating a measurement in the transverse direction.

Tensile properties of the films can be measured as specified by ASTM D882 with static weighing and a constant rate of grip separation. Since rectangular shaped test samples can be used, no additional extensometer is used to measure extension. The nominal width of the tested film sample is 15 mm and the initial distance between the grips is 50 mm. A pre-load of 0.1N was used to compensate for the so called TOE region at the origin of the stress-strain curve. The constant rate of separation of the grips is 5 mm/min upon reaching the pre-load, and 5 mm/min to measure 1% Secant modulus (up to 1% strain). The film samples may be tested in machine direction or in a transverse direction.

Multilayer films of the present disclosure may have one or more of the following properties:
(a) A total thickness of from about 40 mil to about 160 mil, from about 50 mil to about 120 mil, from about 60 mil to about 100 mil, or from about 70 mil to about 90 mil, or from about 75 mil to about 85 mil, or about 80 mil. The thickness of each of the first layer and the third layer may be at least 5% of the total thickness, or from about 10% to about 40%. The thickness ratio between one of the first layer or the third layer and the second layer may be about 1:1 to about 1:6, for example, about 1:1, about 1:2, about 1:3, or about 1:4.
(b) A dart drop impact strength of about 0.5 g/μm or greater, about 1 g/μm or greater, about 2 g/μm or greater, about 3 g/μm or greater, about 5 g/μm or greater, or about 8 g/μm or greater. For example, the dart drop can be from about 0.5 g/μm to about 10 g/μm, from about 1 g/μm to about 8 g/μm, from about 1 g/μm to about 6 g/μm, from about 2 g/μm to about 6 g/μm, or from about 2 g/μm to about 4 g/μm, as determined by ASTM D1709.
(c) A haze value of about 45% or less, about 40% or less, about 35% or less, about 30% or less, about 25% or less, about 20% or less, about 15% or less, or about 10% or less, as determined by ASTM D-1003.
(d) A gloss of about 30% or greater, about 35% or greater, about 40% or greater, about 45% or greater, about 50% or greater, about 55% or greater, about 60% or greater, as determined by ASTM D-2457, where a light source is beamed onto the plastic surface at an angle of 45° and the amount of light reflected is measured.
(e) A 1% secant modulus in the machine direction of about 70 MPa or greater, from about 70 MPa to about 250 MPa, from about 80 MPa to about 200 MPa, from about 90 MPa to about 170 MPa, from about 100 MPa to about 150 MPa, or from about 120 MPa to about 140 MPa, as determined by ASTM D882. 1% Secant modulus is calculated by drawing a tangent through two well defined points on the stress-strain curve. The reported value corresponds to the stress at 1% strain (with x correction) and generally the 1% secant modulus is used for thin film and sheets as no clear proportionality of stress to strain exists in the initial part of the curve.
(f) A 1% secant modulus in the transverse direction of about 250 MPa or less, about 200 MPa or less, or about 170 MPa or less. For example, the 1% Secant Modulus perpendicular to the machine direction can be from about 70 MPa to about 250 MPa, from about 80 MPa to about 200 MPa, from about 90 MPa to about 170 MPa, from about 100 MPa to about 150 MPa, from about 110 MPa to about 140 MPa, from about 120 MPa to about 140 MPa, from about 100 MPa to about 200 MPa, or from about 110 MPa to about 170 MPa, as determined by ASTM D882;
(g) A tensile strength at break in the machine direction of about 10 MPa or greater, about 15 MPa or greater, about 20 MPa or greater, about 25 MPa or greater, or about 30 MPa or greater, as determined by ASTM D822;
(h) An Elmendorf tear strength in the machine direction of at about 1 g/μm or greater, about 2 g/μm or greater, about 4 g/μm or greater, or about 5 g/μm or greater. For example, the Elmendorf tear strength in the machine direction can be from about 1 g/μm to about 15 g/μm, from about 2 g/μm to about 10 g/μm, from about 4 g/μm to about 8 g/μm, from about 5 g/μm to about 8 g/μm, or from about 3 g/μm to about 9 g/μm, as determined by ASTM D1922, which measures the energy used to continue a pre-cut tear in the test sample, expressed in (g/μm). Samples are cut across the web using the constant radius tear die and should be free of visible defects (e.g., die lines, gels, etc.);

### Multilayer Film Production

Also provided are methods for making multilayer films. A method for making a multilayer film may include: extruding a first layer, a second layer disposed on the first layer, and a third layer disposed on the second layer, where the first layer includes a ECA copolymer; the second layer includes a polyethylene or a polyethylene composition; and the third layer includes a polyethylene or a polyethylene composition. In at least one embodiment the ECA polymer has a density of about 0.934 or less, about 0.932 or less, about 0.93 or less, about 0.928 or less, or about 0.926 or less, such as from about 0.922 to about 0.934, or from about 0.924 to about 0.93. In some embodiments, the second layer includes an EAO copolymer. In at least one embodiment, the second layer includes an EH copolymer having a density of about 0.92 g/cm³ to about 0.94 g/cm³, and a MI_{2.16} of about 0.1 g/10 min to about 1.5 g/10 min. In some embodiments, the third layer includes an EAO copolymer. In at least one embodiment, the third layer includes an EH copolymer having a density of about 0.91 g/cm³ to about 0.92 g/cm³, and a MI_{2.16} of about 0.1 g/10 min to about 1.5 g/10 min.

In another embodiment, a method of making a multilayer film further includes: extruding a fourth layer disposed between the first layer and the second layer.

In another embodiment, a method of making a multilayer film further includes: extruding a fifth layer disposed between the second layer and the third layer.

Multilayer films of the present disclosure may be formed by any suitable techniques including blown extrusion, cast extrusion, coextrusion, or casting. The materials forming each layer may be coextruded through a coextrusion feedblock and die assembly to yield a film with two or more layers adhered together but differing in composition. Coextrusion may be adapted to cast film or blown film processes. Certain combinations of polyethylenes can provide films having desired physical and optical properties. Multilayer films may also be formed by combining two or more single layer films prepared as described above.

As a specific example, blown films can be prepared as follows: The polymer composition is introduced into the feed hopper of an extruder, such as a 50 mm extruder that is water-cooled, resistance heated, and has an L/D ratio of 30:1. The film can be produced using a 28 cm W&H die with a 1.4 mm die gap, along with a W&H dual air ring and internal bubble cooling. The film is extruded through the die into a film cooled by blowing air onto the surface of the film. The film is drawn from the die typically forming a cylindrical film that is cooled, collapsed and, optionally, subjected to a desired auxiliary process, such as slitting, treating, sealing, or printing. Typical melt temperatures are from about 180° C. to about 230° C. The rate of extrusion for a blown film is generally from about 0.2 to about 2 kilograms per hour per millimeter of die diameter. The finished multilayer film can be wound into rolls for later processing.

The number of layers in multilayer films can depend on a number of factors including, for example, the desired properties of the film, the end use application for the film, the desired polymers to be used in each layer, the desired thickness of the film, whether the film is formed by a cast film process, and others.

### EXAMPLES

### General

A series of films were produced to evaluate the impact of replacing EVA in a three layer functional greenhouse film with an EAA copolymer resin. The film structure was an A/B/C style at a thickness ratio of 1:1:1, with A representing what would be the outside of a hypothetical greenhouse film, and C being the inside layer. In this study, all fabrication conditions were held constant, with only the composition of layer C changing.

Films were fabricated on a blown film line to a thickness of four mils at a blow up ratio (BUR) of 2.5 and a die gap of 30 mil. Total resin flow rate through the die was maintained at approximately 10 lb/hr/in-circumference, and frost line height maintained at approximately 26 inches. Melt temperatures were adjusted to match the rheology of the different layers, and typically ranged from 375° F. to 430° F., depending on the resins being extruded—with LLDPE resins at higher temperatures, and EVA resins at lower temperatures.

The composition of the three films are as follows:

Comparative Example 1: An EVA reference film was made with Exceed™ XP 6056, an EH copolymer with an density of 0.916 g/cm³ and an MI_{2.16} of 0.5 g/10 min in layer A, Escorene™ Ultra FL00018, a copolymer of ethylene and vinyl acetate with a density of 0.94 g/cm³ and an MI_{2.16} of 0.37 g/10 min in layer B, and Escorene™ Ultra FL00112, a copolymer of ethylene and vinyl acetate with a density of 0.934 g/cm³ and an MI_{2.16} of 0.5 g/10 min in layer C. Each layer was composed of 10% pre-blended masterbatch containing anti-dripping agent KF-650, a blend of sorbitan palmitate and glycerol mono 12-hydroxy stearate (Riken Vitamin Co., LTD, Japan).

Example 1: An EAA film was made with Exceed™ XP 6056, an EH copolymer with an density of 0.916 g/cm³ and an MI_{2.16} of 0.5 g/10 min in layer A, Escorene™ Ultra FL00018, a copolymer of ethylene and vinyl acetate with a density of 0.94 g/cm³ and an MI_{2.16} of 0.37 g/10 min in layer B, and a copolymer of ethylene and acrylic acid with a density of 0.926 g/cm³ and an MI_{2.16} of 1.5 g/10 min in layer C. Each layer was composed of 10% pre-blended masterbatch containing anti-dripping agent KF-650, a blend of sorbitan palmitate and glycerol mono 12-hydroxy stearate (Riken Vitamin Co., LTD, Japan).

The properties of this film demonstrate the value of ECA based resins versus EVA based greenhouse film structures.

Comparative Example 2: A third film of similar structure to the EVA reference film was fabricated with Exceed™ XP 6056, an EH copolymer with an density of 0.916 g/cm³ and an MI_{2.16} of 0.5 g/10 min in layer A, Escorene™ Ultra FL00018, a copolymer of ethylene and vinyl acetate with a density of 0.94 g/cm³ and an MI_{2.16} of 0.37 g/10 min in layer B, and a blend of 40% Escor™ 5000, an EAA with 6 wt % acrylic acid a density of 0.93 g/cm³ and an MI_{2.16} of 8.2 g/10 min and 60% ExxonMobil™ LD103.09 with a density of 0.919 g/cm³ and an MI_{2.16} of 1.1 g/10 min in layer C. Each layer was composed of 10% pre-blended masterbatch containing anti-dripping agent KF-650, a blend of sorbitan palmitate and glycerol mono 12-hydroxy stearate (Riken Vitamin Co., LTD, Japan). This represents a similar acid content to the EAA film of Example 1, but derived from a blend instead of a pure resin layer. The properties of this film demonstrate the value gained by having an ECA resin tailored to greenhouse applications.

TABLE 1
Measured properties of significance for the three films produced.

| Sample ID | Comparative Ex 1 | Ex 1 | Comparative Ex 2 |
|---|---|---|---|
| Inner layer composition | EVA | EAA | EAA/LDPE |
| 1% Secant Modulus (psi) | | | |
| Machine Direction | 14000 | 19000 | 16000 |
| Transverse Direction | 13000 | 21000 | 16000 |
| Creep Strain (%) | | | |
| Machine Direction | 44 | 21 | 30 |
| Transverse Direction | 59 | 39 | 49 |
| Yield Strength (psi) | | | |
| Machine Direction | 800 | 1100 | 1000 |
| Transverse Direction | 800 | 1100 | 900 |
| Coefficient of Friction (I/I) | | | |
| Static | >1 | 0.397 | 0.315 |
| Kinetic | >1 | 0.352 | 0.274 |
| Haze (%) | 5.9 | 17.7 | >30 |

Creep is a tensile creep measurement. Creep is determined by applying a load equivalent to 80% of the yield strength of the film for a period of 7 days. #H-8730 Hoffman clamps with #3 swivels and #5 stainless steel split rings are used to apply to load to the films. The test is performed in an environmentally controlled laboratory at 23+/−2° C. and 50% humidty (+/−10%), with testing to begin at least 48 hours after film fabrication. The creep strain percentage is calculated as the percent increase in length of the film after seven days. Creep Strain=(Length final/Length initial−1)×100%.

1% secant modulus and yield strength measurements are determined using ASTM D882. The coefficient of friction (COF) between the inner layers of the film was determined using ASTM D1894. The inner layer COF was measured as this was the only layer changing in the film composition, and represents the layer that would come into contact with support structures of greenhouse films. Haze was measured ASTM D1003.

As shown in Table 1, implementing ECA as a pure layer with low acid content and low melt index showed considerable improvements in many aspects of film properties compared to EVA and ECA/LD blends used in the inner layer. Despite the significantly higher load applied to EAA based Film of Ex 1 (due to higher yield strength) during creep testing, it still performed considerably better than comparative films containing EVA or EAA/LD blends in the inner layer. The improvements in stiffness and creep could not be replicated through the use of polymer blends with similar blended acid content and overall density or the EVA based resin formulation. Film of Ex 1 also demonstrated a lower kinetic and static coefficient of friction compared to the EVA based films, indicating it would be easier to apply these films to greenhouse support structures, or would require less slip agents to be used in the films.

Based on the design on the ECA copolymer, it is expected that Film of Ex 1 will perform similarly or better than Film of Comparative Ex 1 in a water bath test designed predict anti-drip/anti-fog performance of greenhouse films. Compared to Film of Comparative Ex 2, Film of Ex 1 is expected to have superior performance, due to the differences in resin miscibility causing poor retention of the anti-drip additive. Without being limited to theory, it is believed that the increased crystallinity of the ECA will disrupt the diffusion of additives through the resin, which in conjunction with increased bonding strength of the carboxylic acid compared to the carbonyl group of EVA, will reduce the rate at which the anti-drip is extracted from the film. This would indicate that despite a lower mol % functional moiety in the copolymer (1.0 mol % AA vs 4.3 mol % EVA), it is expected that the EAA based Film of Ex 1 will likely perform similarly or better than EVA based Film of Comparative Ex 1. The overall performance of ECA resins is likely to depend on where the resin is used in the film structure, and the other resins present in additional layers. This should lead to similar to superior performance in anti-drip/anti-fog performance in such applications as greenhouse films, produce films, and freezer bags, while retaining superior performance in stiffness, creep strain reduction, and lower coefficient of friction while maintaining acceptable haze.

Overall, it has been discovered that a multilayer film including a layer of about 100 wt % ECA, such as EAA, EMAA, EPAA, or EBAA (based on the total weight of the polymer in that layer) with an MI of about 0.1 g/10 min to about 2 g/10 min, and an acrylic acid content of about 0.4 mol % to about 2.4 mol % may provide improved retention of anti-fog and anti-drip additives, high clarity, low haze, and low stickiness for use in greenhouse applications. The grade of EAA also affects its potential use as a greenhouse covering. Additionally, the use of a layer of about 100 wt % EAA based on the total weight of the polymer in that layer avoids the use of a blend of EAA and other polyolefins (such a LDPE), which blends may have decreased optical properties, such as lower clarity and higher haze. Furthermore, the addition of EAA to multilayer films provides improved stiffness, and creep resistance.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of this disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of this disclosure have been illustrated and described, various modifications can be made without departing from the spirit and scope of this disclosure. Accordingly, it is not intended that this disclosure be limited thereby. Likewise whenever a composition, an element or a group of elements is preceded with the transitional phrase “including,” it is understood that we also contemplate the same composition or group of elements with transitional phrases “consisting essentially of,” “consisting of,” “selected from the group of consisting of,” or “is” preceding the recitation of the composition, element, or elements and vice versa. The compositions, films, and processes disclosed herein suitably may be practiced in the absence of any element which is not specifically disclosed herein.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A copolymer comprising ethylene units and α,β unsaturated carboxylic acid units, the copolymer comprising from about 0.4 mol % to about 1.1 mol % of the α,β unsaturated carboxylic acid units, and the copolymer having a melt index of from about 0.1 g/10 min to about 2 g/10 min.

2. The copolymer of claim 1, wherein the α,β unsaturated carboxylic acid units are selected from the group consisting of acrylic acid, methacrylic acid, ethylacrylic acid, propylacrylic acid, and butylacrylic acid.

3. The copolymer of claim 1 wherein the copolymer comprises from about 0.6 mol % to about 1.1 mol % of the α,β unsaturated carboxylic acid units.

4. The copolymer of claim 1, wherein the copolymer comprises from about 0.8 mol % to about 1.0 mol % of the α,β unsaturated carboxylic acid units.

5. The copolymer of claim 4, wherein the copolymer has one of the following:
(a) a melt index (MI_{2.16}) of from about 0.5 g/10 min to about 1.5 g/10 min;
(b) a melt index (MI_{2.16}) of from about 1 g/10 min to about 1.6 g/10 min;
(c) a melt index (MI_{2.16}) of from about 1.2 g/10 min to about 1.8 g/10 min.

6. The copolymer of claim 1, wherein the copolymer has a melt index ratio (MI_{21.6}/MI_{2.16}) of from about 20 to about 70.

7. The copolymer of claim 6, wherein the copolymer has a melt index ratio (MI_{21.6}/MI_{2.16}) of from about 30 to about 60.

8. The copolymer of claim 7, wherein the copolymer has a melt index ratio (MI_{21.6}/MI_{2.16}) of from about 40 to about 50.

9. The copolymer of claim 1, wherein the copolymer comprises about 90 wt % or greater of ethylene units.

10. The copolymer of claim 1, wherein the copolymer has a density of from about 0.92 g/cm³ to about 0.94 g/cm³.

11. The copolymer of claim 1, wherein the copolymer has one or more of the following:
(i) a peak melting point of from about 95° C. to about 115° C.;
(ii) a Vicat softening point of from about 80° C. to about 105° C.

12. A copolymer comprising ethylene units and α,β unsaturated carboxylic acid units, the copolymer comprising from about 0.4 mol % to about 2.4 mol % α,β unsaturated carboxylic acid units, and the copolymer having a melt index of from about 0.1 g/10 min to about 1.4 g/10 min.

13. The copolymer of claim 12, wherein the α,β unsaturated carboxylic acid units are selected from the group consisting of acrylic acid, methacrylic acid, ethylacrylic acid, propylacrylic acid, and butylacrylic acid.

14. The copolymer of claim 12, wherein the copolymer comprises from about 0.8 mol % to about 1.2 mol % α,β unsaturated carboxylic acid units.

15. The copolymer of claim 14, wherein the copolymer has one or both of the following:
(a) melt index (MI_{2.16}) of from about 1 g/10 min to about 1.4 g/10 min; and
(b) melt index ratio (MI_{21.6}/MI_{2.16}) of from about 30 to about 60

16. The copolymer of claim 12, wherein the copolymer comprises about 90 wt % or greater of ethylene units.

17. The copolymer of claim 12, wherein the copolymer has a density of from about 0.92 g/cm³ to about 0.94 g/cm³.

18. The copolymer of claim 12, wherein the copolymer has one or more of the following:
(i) a peak melt temperature of from about 95° C. to about 115° C.; and
(ii) a Vicat softening point of from about 80° C. to about 105° C.
